(19) United States
(12) Patent Application Publication
(10) Pub. No.: US 2026/0002832 A1
(43) Pub. Date: Jan. 1, 2026

(54) MULTI-DEGREE-OF-FREEDOM FIXTURE FOR AUTOMATED RECIPROCAL FREQUENCY RESPONSE FUNCTION MEASUREMENTS

(71) Applicant: Robert Bosch GmbH, Stuttgart (DE)

(72) Inventors: Michael Sturm, Milford, MI (US); Kevin Wienen, Farmington Hills, MI (US); Michael Yankonis, Whitmore Lake, MI (US)

(21) Appl. No.: 18/760,887

(22) Filed: Jul. 1, 2024

(51) Int. Cl. G01M 7/02

(52) U.S. Cl. CPC G01M 7/022

(57) ABSTRACT

System and methods for characterizing system response functions of a structure-under-test (SUT). One system includes a fixture coupleable at a coupling interface to the SUT and configured to hold the SUT at a known position and orientation relative to the fixture. The system includes exciter devices coupled downstream from the coupling interface at different locations and orientations and are configured to each apply an excitation force to the fixture. The system includes response sensors positioned at a known location and orientation relative to the fixture. Each response sensor is configured to sense a dynamic response, wherein the excitation force applied to the fixture by the exciter devices is transferred by the fixture to the SUT, and wherein the dynamic response measured by each of the response sensors is indicative of a reciprocal response of the fixture to the applied force.

### BACKGROUND

The systems and methods described herein relate to measuring a system response function of a system or structure. In some implementations, the examples described herein relate to systems and methods for applying an excitation force to a system or structure and measuring a response of the system or structure to the applied excitation force.

### SUMMARY

A system response function (SRF) is a representation of a system's behavior in response to a particular input signal or stimulus. It is possible to determine an SRF by applying a known excitation force to a structure-under-test and then measuring a resulting response (e.g., an acceleration response). To obtain meaningful results, one or more exciter devices and one or more response sensors are coupled to the structure-under-test in different directions (e.g., x, y, and z directions of the Cartesian coordinate system). The exciter devices may include, for example, a shaker device configured to apply a vibrational force or an impact force to the structure-under-test and the response sensors may include, for example, accelerometers. As such, a system response function describes the input-to-output relation between the location of the excitation (input) and response (output) measurement. The principle of reciprocity may be used (for linear, time invariant systems) to interchange the location of the input and output in the SRF measurement.

In some instances, the exciter devices and response sensors may be installed permanently on the structure-under-test. However, permanent installation requires that new instrumentation be used to measure the SRF for each different structure. When measuring the SRF for a plurality of different structures (e.g., assembled in a production line), using new instrumentation for each structure can increase production cost and introduce experimental uncertainties and errors between measurements due to inaccuracies and variations in the instrumentation). Conversely, if the same set of instrumentation is used for SRF measurements on multiple different structures by temporarily installing the instrumentation on each structure, experimental uncertainties and measurement errors can still result due to variations in instrumentation placement and possible changes to the instrumentation due to repeated attachment, removal, and associated handling.

Accordingly, in various implementations, the systems and methods described in this disclosure provide a fixture for permanent installation of measurement hardware at pre-defined positions for quick and reliable automated SRF measurements. In some implementations, the fixture is coupled to a test bench and configured to hold a structure-under-test during the SRF measurement process. After the SRF measurement process is completed, the structure-under-test is removed (e.g., decoupled from the fixture) and another structure-under-test is selectively coupled to the fixture for SRF measurement. In this way, the instrumentation (e.g., the exciter devices and the response sensors) of the fixture remain in place while different structures are coupled to the fixture for SRF measurements. The placement of each exciter device and response sensor relative to the other exciter devices and response sensors and relative to the structure-under-test also thus remain constant for the SRF measurements for each different structure for, among other things, to allow for consistent data acquisition.

One approach for measuring SRF for a coupled system, such as a structure-under-test coupled on a fixture (for example, as described in U.S. Pat. No. 11,781,941), is to apply excitation on the structure-under-test or its coupling interface and measure the response downstream on the fixture (which may be referred to as a “direct” measurement approach). The systems and methods described herein are generally directed to another approach for measuring SRF where the excitation and response positions are interchanged. That is, an excitation force is applied on the fixture and the dynamic responses are measured upstream in the proximity of the SUT (referred to herein as a “reciprocal” measurement approach).

As described above, the structure-under-test is coupled on the fixture. In some implementations, one or more response sensors (for example, accelerometers) are then positioned on the structure-under-test for SRF measurements between the permanently installed exciter devices and the response sensors of the fixture. In this way, SRF measurements are obtained to locations on the structure-under-test while still allowing for low measurement error and low uncertainty due to the unchanged placement of the exciter devices on the fixture.

When measuring the SRF for a plurality of different structures (e.g., different structure of the same design assembled in a production line), installing the instrumentation for each test on the structure-under-test increases testing time and effort. It may also introduce experimental uncertainties and errors between measurements due to inaccuracies and variations in the instrumentation. Conversely, if the same set of instrumentation is used for SRF measurements on multiple different structures by permanently installing the instrumentation on a reciprocal measurement fixture, which in turn is connected to each structure-under-test, experimental uncertainties and measurement errors can be minimized due to no variations in instrumentation placement and possible changes to the instrumentation due to repeated attachment, removal, and associated handling. In some implementations, the fixture operates as “an instrumented washer” to connect the structure-under-test to the test bench. This “instrumented washer” holds all exciters and sensors (which would otherwise be “glued”) to the structure-under-test. Therefore, test results and measurements can be more accurate (no operator uncertainty) and faster, and the Cartesian coordinate system in which measurements are analyzed remains the same during all measurements (the coordinate system is defined by the permanently installed instrumentation).

In some implementations, the reciprocal measurement fixture (including the permanently attached instrumentation) acts as a passive structural component mounted between the structure-under-test and the test bench (similar to a complex designed washer and/or fixture adaptor). The fixture won't alter the intended operation of the structure-under-test (e.g., steering from left to right in a test procedure to characterize the acoustic performance of steering systems on a bench). In some implementations, when the structure-under-test is turned off (no steering maneuver), the exciter devices attached to the fixture are operated one at a time to characterize the SRFs of the system. Alternatively, two or more exciter devices can be operated simultaneously, for example, using uncorrelated excitations to characterize the SRFs faster and to assure that the SUT is properly excited (all vibration modes of interest are excited). To calculate the SRF's, the independent excitation energy from each excitation source, is extracted from each response using, for example, signal decorrelation techniques.

In some instances, the measurement location of interest (e.g., the center of the steering mount) is inaccessible for direct measurement (e.g., force and moment excitation and translational and rotational response measurement in the center of the mount). In such cases, a coordinate transformation may be used to project the force excitations and response measurements on the reciprocal measurement fixture onto a point of interest (e.g., center of the steering mount). In other words, force excitations and response measurements on the fixture (in the proximity of the point of interest) are used to determine “virtual excitations and responses.” In some implementations, the reciprocal measurement fixture is rigid in the area close to the point of interest so that an accurate coordinate transformation can be performed. The impedance fixture behaves like a rigid body in the frequency range of interest (where the SRFs are analyzed, e.g., 0 Hz-3 kHz) without local flexibilities (eigenfrequencies between 0 Hz-3 kHz of the fixture itself in the local area where the coordinate transformation is performed). Otherwise, local flexibilities may lead to an error in the coordinate transformation (which is a linear geometric transformation).

In some implementations, as described above, exciter devices may be positioned at the fixture (i.e., coupling interface) itself and the SRFs of the fixture-structure assembly may be determined as a result of a direct excitation at the coupling interface between the fixture and the structure-under-test and some response measurements further downstream of the interface on the fixture. However, there may also be several advantages to alternatively or additionally measure reciprocal SRFs. Reciprocal SRFs use excitations applied downstream of the structure-fixture coupling interface (e.g., downstream on the fixture itself or on the test bench platform thereof) and response measurements at the coupling interface, the SUT, or some positions on the fixture. In other words, the reciprocal concept determines the same SRFs between the points on the coupling interface and the fixture-side but interchanges the input (exciter device excitation) and output (response measurement) locations. Due to the smaller size of accelerometers compared to exciter devices (for example, shakers), such implementations may allow for use of smaller fixture construction, which thus may enable testing of smaller components beyond that of a steering mount (e.g., printed circuit boards and/or other small electronic/mechanical/mechatronic devices). Such implementations also may allow for a greater variety of exciter devices to be used, for example, to expand the frequency range to lower/higher frequencies and allow for use of a less rigid fixture. Furthermore, measurement of temperature conditioned parts (e.g., high heat or low temperature components) may also be performed as several thermally sensitive components of the system (for example, the exciter devices) are positioned away from the coupling interface whilst thermally robust measurement equipment (e.g., high-temperature accelerometers) can be placed closer to the structure-under test. This also may allow for testing of a structure-under-test to be performed in more kinds of environments (for example, underwater or chemically abrasive).

One implementation provides a system for characterizing system response functions of a structure-under-test. The system includes a fixture selectively coupleable at a coupling interface to the structure-under-test, a plurality of exciter devices, a plurality of response sensors. The fixture is configured to hold the structure-under-test at a known position and known orientation relative to the fixture. Each exciter device of the plurality of exciter devices is coupled downstream from the coupling interface at different locations and different orientations and is configured to controllably apply an excitation force to the fixture. Each of the plurality of response sensors is configured to sense a dynamic response, wherein the excitation force applied to the fixture by each of the exciter devices is transferred by the fixture to the structure-under-test, and wherein the dynamic response measured by each of the response sensors is indicative of a reciprocal response of the fixture to the applied excitation force.

Some implementations provide a method of characterizing a system response function using the system described above. The method includes coupling a first structure-under-test to the fixture, selectively and controllably operating the plurality of exciter devices to apply a plurality of excitation forces to the first structure-under-test, receiving force response data from the plurality of response sensors indicative of the response of the first structure-under-test to each of the applied excitation forces, and applying a mathematical coordinate transformation to project translational and rotational dynamic responses sensed by the response sensors to a target point of the fixture and the first structure-under-test coupled to the fixture. The method further includes calculating a system response function for the fixture and the first structure-under-test coupled to the fixture based at least in part on the projected responses and the excitation forces. In some implementations, the excitation forces, in part, may also be projected into a target point of interest.

Other aspects of the invention will become apparent by consideration of the detailed description and accompanying drawings.

### BRIEF DESCRIPTION OF THE DRAWINGS

FIG. 1 is a perspective view of a schematic diagram of excitation forces applied to a fixture with a coupled structure-under-test and response accelerations measured during the SRF measurement process.

FIG. 2A is a perspective view of a fixture for selectively holding a structure-under-test during the SRF measurement process according to one implementation.

FIG. 2B is another perspective view of a fixture for selectively holding a structure-under-test during the SRF measurement process according to one implementation.

FIG. 3 is a block diagram of a control system for an automated SRF measurement process.

FIG. 4 is a flowchart of a method for performing the automated SRF measurement process using the system of FIG. 3.

FIG. 5 is a flowchart of another example of a method for performing the automated SRF measurement process using the system of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of examples, aspects, and features illustrated.

In some instances, the apparatus and method components have been represented where appropriate by conventional symbols in the drawings, showing only those specific details that are pertinent to understanding of the various embodiments, examples, aspects, and features so as not to obscure the disclosure with details that will be readily apparent to those of ordinary skill in the art having the benefit of the description herein.

### DETAILED DESCRIPTION

For case of description, some or all of the example systems presented herein are illustrated with a single exemplar of each of its component parts. Some examples may not describe or illustrate all components of the systems. Other example implementations may include more or fewer of each of the illustrated components, may combine some components, or may include additional or alternative components.

It should be understood that although certain figures presented herein illustrate hardware and software located within particular devices, these depictions are for illustrative purposes only. In some implementations, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

It should be understood that, although certain implementations described herein are in terms of the structure-under-test being a steering gear, the systems and methods described herein are applicable to any kind of structural component including those beyond vehicular components (for example, small appliances, small engine systems, and the like).

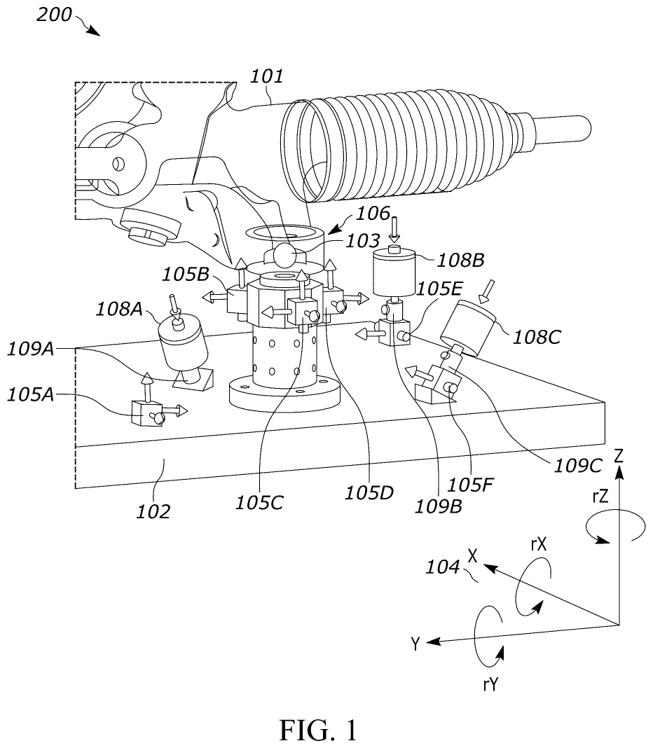

FIG. 1 illustrates an example of a test bench system 200 including a fixture 102 for selectively coupling to a structure-under-test (SUT) (which in one example is a steering gear) 101. The fixture 102 may further be coupled to a test bench platform or surface (not shown) downstream from the coupling of the SUT and the fixture 102. While coupled to the fixture 102, the steering gear 101 undergoes a process for determining a system response function (SRF) at a center point 103 of a steering mount 106 of the steering gear 101. In some implementations, SRFs need to be characterized between one or more remote locations downstream on the fixture 102 and some center point 103 at the coupling interface of the SUT and the fixture 102 (for example, at the steering mount 106). To determine the dynamics at the center point 103, in some implementations (e.g., when the location is inaccessible for direct measurement), mathematical coordinate transformations are used to project responses onto the point of interest. For example, in some implementations, the process measures a combined system response of the steering system 101 and the fixture 102 to which the steering system 101 is coupled in the x, y, and z-directions of the cartesian coordinate system and the corresponding rotations rX, rY, and rZ, as indicated by the reference legend 104 in FIG. 1. In some implementations, this type of SRF characterization may be performed by applying force and moment excitation in the different Cartesian and rotational directions and measuring the resulting rectilinear and angular acceleration response. To reduce system, measurement, and calculation complexity, in some other implementations, mathematical coordinate transformations are used to project forces and responses onto the point of interest (e.g., the center point 103 of the steering mount). In the example of FIG. 1, the arrows extending from exciter devices 108A-108C represent applied forces and the arrows extending from the cube-shaped tri-axial accelerometers 105A-105F represent actual responses. Accordingly, measurements in the area close to the target position (e.g., the center point 103) can be used to obtain projected translational and rotational information. However, this requires a relatively high-accuracy knowledge of the position and direction of each force/response measurement relative to the point of interest (e.g., the center point 103).

As described above, a plurality of response sensors (e.g., accelerometers) are configured onto a fixture that is selectively couplable to a SUT (for example, the steering gear 101 of FIG. 1) at a known, fixed location (e.g. at a coupling interface) and a plurality of exciter devices (e.g., “shakers” configured to apply a vibrational force by alternating linear movement of a weighted body of the shaker) downstream of the location. In some implementations, one or more of the exciter devices may include a respective load measuring or force measuring response sensor for applying a predetermined amount of excitation force. For example, as shown in FIG. 1, exciter devices 108B and 108C are each mounted on a respective response sensor 105E and 105F. In some implementations, as illustrated in FIG. 1, both of a load measuring sensor (for example, load measuring sensors 109A-109C) and a response sensor (for example, sensors 105E and 105F) may be embedded in an exciter device.

In some implementations, the plurality of response sensors include one or more laser vibrometers (for example, instead of accelerometers) to measure the vibration responses. Such an implementation may be utilized, for example, for SRF measurements on light-weight structures for contactless measurement.

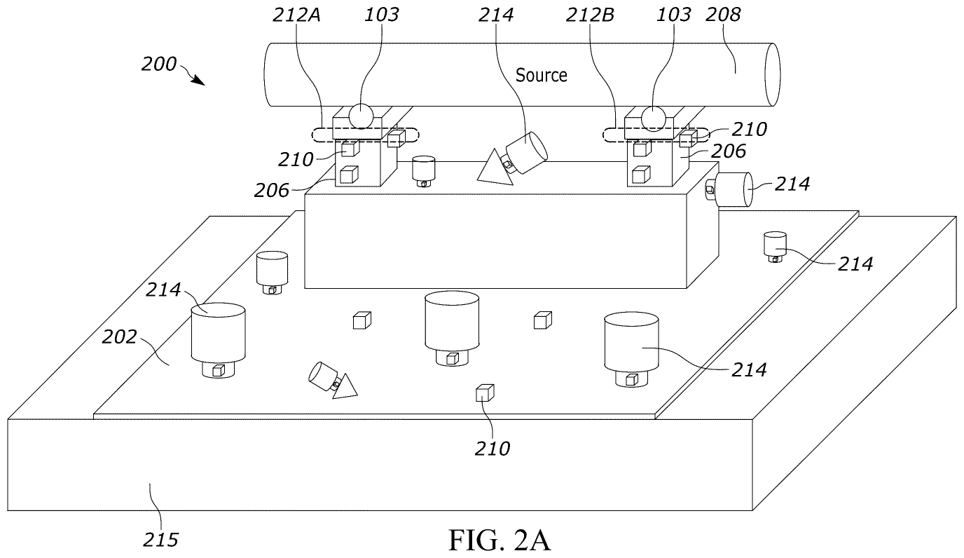

FIG. 2A illustrates another example of the test bench system 200 for selectively coupling to a SUT during the SRF measurement process according to some implementations. The test system 200 includes a fixture 202 including one or more fixture adaptors 206 configured to selectively couple to an SUT 208 (for example, the steering mounts of a steering gear as illustrated in FIGS. 1 and 2B). In some implementations, the system 200 includes any number of fixture adaptors 206. The fixture 202, in some implementations, is connected to a test bench platform 215.

FIG. 2B illustrates another example of the test system 200 including exemplary structures of the fixture adaptors 206. It should be understood that although each fixture adaptor 206 is illustrated as being cylindrical in FIG. 2B, the fixture adaptors 206 may be structured differently in some implementations. As illustrated in both FIG. 2A and 2B, each fixture adaptor 206 includes a plurality of response sensors 210 installed thereon. The response sensors 210 include at least one sensor coupled at a coupling interface (for example, coupling interfaces 212A, 212B of FIG. 2A and coupling interfaces 212A-212D of FIG. 2B) of the respective fixture adaptor 206 and the SUT 208 (for example, on the fixture adaptor 206). In some implementations, the response sensors 210 are or include at least one accelerometer for measuring the vibration response due to an applied excitation force, the system response to the applied excitation force, or both. Additionally, in some implementations (as also illustrated in the example of FIG. 2A and 2B), one or more tri-axial response sensors 210 may also be coupled to other vibrating received parts (e.g., a plate that connects the fixture adaptors 206 to the rest of the fixture 202). The example of FIG. 2A also illustrates other tri-axial response sensors 210 positioned at other locations that may be used in addition to the positions of the response sensors 210 at the coupling interfaces 212A, 212B. Alternatively or additionally, in some implementations, one or more of the response sensors 210 are coupled to or incorporated within the fixture 202. Additionally or alternatively, in some implementations, one or more of the response sensors are positioned on the SUT 208.

In some implementations, sensors 210 may be realized as impedance heads, thus measuring the response and the imparted force at the same location below an attached exciter device. Impedance head sensors may be used for realizations in which force excitation is applied at the coupling interface (for example, as depicted in FIG. 2B).

The system 200 also includes a plurality of exciter devices 214 positioned downstream from the coupling interface 212A, 212B (for example, on a mounting position such as the fixture adaptor 206, downstream from the mounting position/fixture adaptor 206 on the fixture 202, a component physically coupled between the fixture adaptor(s) 206 and the rest of the fixture 202, or some combination thereof). Each exciter device 214 is configured to generate an excitation force (e.g., a vibrational force and/or an impact force) in accordance with an excitation signal (described in more detail below) in response to receiving the excitation signal. The plurality of exciter devices 214 are positioned at locations and orientations configured to apply linear vibrational forces in various directions and/or orientations to excite vibration responses at the target point (for example, center point 103) of the SUT 208 that after coordinate transformation align with the x,y,z directions and/or their corresponding rotations (rX, rY, and rZ).

In some implementations, the exciter devices 214 are electro-magnetically actuated devices and the control signal is provided in the form of an alternating electrical current that is applied to an electromagnet coil of the exciter device 214 to drive movement of a weighted body of the exciter device 214. In other implementations, the exciter devices 214 may be actuated, for example, pneumatically, hydraulically, or mechanically (e.g., a device with a pretensioned spring that is released to apply an impact). In some implementations, more than one type of exciter device 214 is utilized in the system 200. The plurality of exciter devices 214, in some implementations, include one or more of a vibrational shaker device, each device configured to apply a vibration force along an operating axis of the vibrational shaker device.

As the exciter devices 214 generate the excitation force, the excitation force is applied to (and transfers through) the structural components of the system 200 from its position downstream of the coupling interface 212A, 212B (for example, depending on the particular position of the exciter device 214, through the fixture 202 or where the fixture 202 is structurally coupled to the test bench platform 215). The excitation force applied to the fixture 202 by each of the exciter devices 214 is transferred by the fixture 202 to the SUT 208 (for example, through the adaptors 206). Each of the response sensors 210 measures a resulting dynamic response that is indicative of a reciprocal response of the fixture to the applied excitation force.

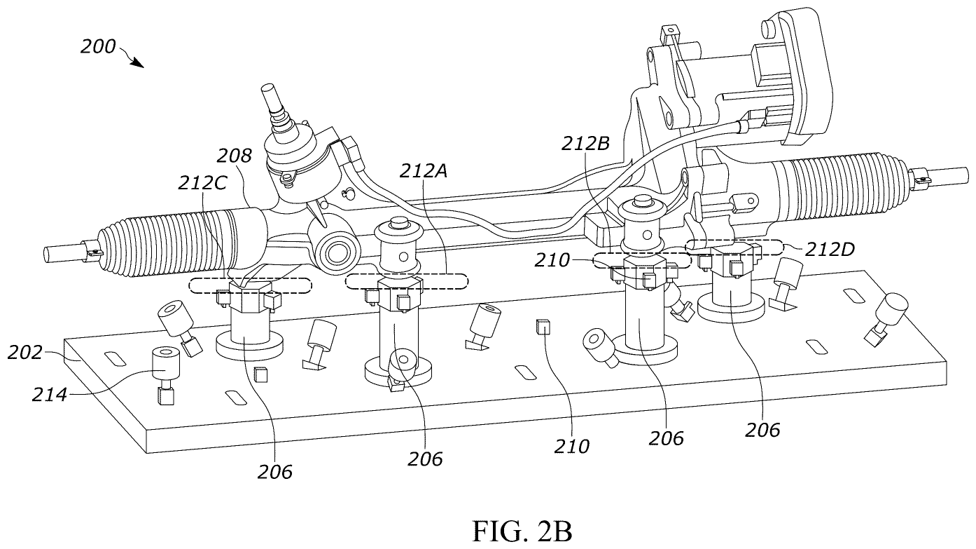

FIG. 3 illustrates an example of a control system 300 for performing a series of multi-degree of freedom excitation/response measurements of a SUT. A controller 302 includes an electronic processor 304 and a non-transitory computer-readable memory 306. The memory 306 stores data and/or computer-executable instructions. The electronic processor 304 is communicatively coupled to the memory 306 and executes the instructions stored on the memory 306 to provide the functionality of the controller 302 (including, for example, the functionality described herein).

The memory 306 may include a program storage area and a data storage area. The processor 304 is connected to the memory 306 and executes computer readable code (“software”) stored in a random access memory (RAM) of the memory (e.g., during execution), a read only memory (ROM) of the memory (e.g., on a generally permanent basis), or another non-transitory computer readable medium. The software may include firmware, one or more applications, program data, filters, rules, one or more program modules, and/or other executable instructions. In some embodiments, some or all of the software and data stored in the memory 306 may also be stored in and retrieved from one or more databases remote from the controller 302. The memory 306 stores, for example, the known locations and know orientations of the plurality of exciter devices 214 and the plurality of response sensors 210 relative to the fixture 206 (for example, as described above with respect to the fixture coordinate system 104 of FIG. 1). The memory 306 may store, for example, a known arrangement of the plurality of exciter devices 214 and the plurality of response sensors 210 on the system 200 downstream of the coupling interface 212A, 212B and a known geometry of at least one of the fixture 202, the fixture adaptor 206, the SUT 208, and the test bench platform.

The controller 302 is communicatively coupled to the plurality of response sensors 210 and the plurality of exciter devices 214. In some implementations, the response sensors 210 each include one or more accelerometers (or, for example, a tri-axial accelerometer). When the excitation force is applied to the SUT 208 (e.g., a steering system) by an exciter device 214 downstream from the coupling interface 212A, 212B, the response sensors 210 measure how the SUT 208 (and the respective fixture adaptor 206 attached thereto) responds to the applied excitation force (e.g., how an applied force travels through system 200 from one location to another location) and each transmit a signal to the controller 302 indicative of the measured response (e.g., a measured acceleration, velocity, and/or displacement). In some implementations, where the testing is performed using the reciprocal fixture, the dynamic response of the connected parts (e.g., the SUT, the fixture 206, and any other components that might be coupled thereto) is measured by the response sensors 210 in order to perform an in-situ blocked force measurement. In some implementations, response sensors 210 may be positioned proximal to an exciter device 214 and configured to transmit a signal to the controller 302 indicative of the dynamic structural response of system 200 at the exciter device 214 location.

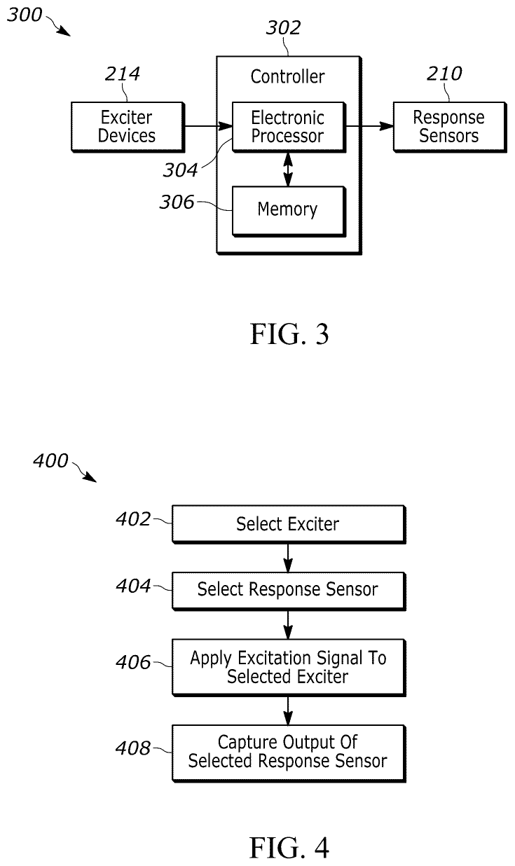

FIG. 4 illustrates a first example of a method 400 performed by the controller 302 for collecting measurement data when a SUT is coupled to a fixture that is equipped with the instrumentation as described herein. The controller 302 selects a particular exciter device 214 of the plurality of exciter devices 214 (step 402) and selects a particular response sensor 210 of the plurality of response sensors 210 (step 404). The controller 302 then induces the excitation force into the system 200 by applying an excitation signal to the selected exciter device 214 (step 406) and measures the response based on the output signal from the selected response sensor (step 408).

Due to the particular positioning of the response sensors 210, the measurements of the response sensors 210 are indicative of a reciprocal response of the fixture 202 (including the fixture adaptor 206) to the applied excitation force. Excitation signals are applied downstream from the coupling interface 212 and the resulting reciprocal vibration response are measured at the coupling interface 212 (e.g., point of interest 103) or, in some implementations, on the SUT 208. In some implementations, where an SRF measurement is determined as a measured response referenced to an applied force, the induced force must also be known. Accordingly, in some implementations, a force sensing device (for example, a load cell) is also included (e.g., installed between the exciter device and the fixture) and used to measure the actual force applied by the exciter device 214. In some implementations, the controller 302 may be configured to repeat the process of FIG. 4 for multiple different exciter device/response sensor combinations to collect enough data to fully characterize the SRF of the system 200.

In some implementations, the controller 302 is further configured to apply a mathematical coordinate transformation to determine the excitation forces and corresponding responses at the target point of the SUT 208 (e.g., the center point 103 of the steering gear 101 in the example of FIG. 1). In some implementations, the controller 302 is configured to perform this mathematical coordinate transformation using one or more of the following: a virtual point transformation, a finite difference approximation, and a multi-point connection. Also, in some implementations, the computational functionality described herein is distributed across multiple different controllers/computers. For example, a first controller may be used to operate the exciter devices while a second different computer system is configured to receive the sensed data from the response sensors and/or load cells and to perform the coordinate transformation as a post-processing step (e.g., using MATLAB or software).

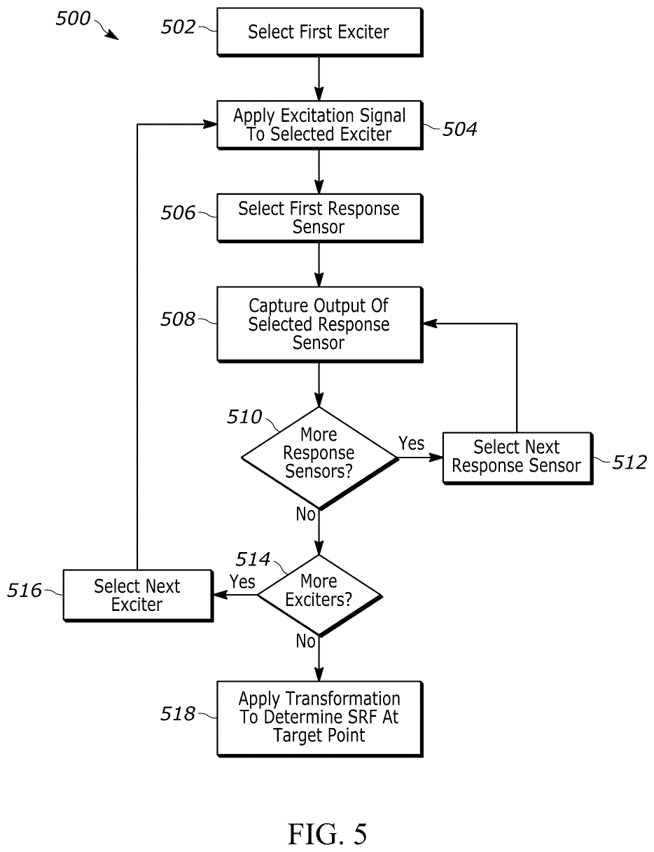

FIG. 5 illustrates an example of a method 500 performed by the controller 302 for using a mathematical transformation to determine the SRF at a target point of the SUT (e.g., the center point 103 of the steering gear 101 in the example of FIG. 1). The method 500 may include more or less steps than illustrated. Additionally, steps of the method 500 may be performed in a different order. For example, although the transformation performed at step 518 described below is performed following capturing outputs from all of the plurality of response sensors 210 (step 514), in some implementations, the transformation at step 518 is performed following collection from a response sensor 210 (for example, following step 508). The controller 302 selects a first exciter device of the plurality of exciter devices 214 (step 502) and applies an excitation signal to the selected exciter device (step 504) (while, in some implementations, also measuring the actual applied excitation force using a load cell coupled to the exciter device 214). The controller 302 then selects a first response sensor of the response sensors 210 (step 506) and captures the output of the selected response sensor (step 508). The controller 302 then selects the next response sensor of the plurality of response sensors 210 (step 510) while continuing to apply the excitation signal to the selected exciter device and captures the output of the next selected response sensor (step 512). This is repeated until the controller 302 has received a response signal from each of the plurality of response sensors 210 (step 514). In the example of FIG. 5, only one exciter device of the plurality of exciter devices 214 is activated at each time and the output of the response sensors of each of the plurality of response sensors 210 are read serially. However, in other implementations, the system 200 is configured to read the output of all response sensors 210 simultaneously using a multi-channel data acquisition system. Additionally, in some implementations, the system 200 is designed to operate the exciter devices 214 to apply excitation forces from multiple different exciter devices simultaneously in addition to or instead of operating the exciter devices 214 one-at-a-time. In some implementations, each of the exciter devices 214 are operated with different excitation signals (e.g, different magnitudes and/or frequencies of force) simultaneously or, alternatively, one-at-a-time.

After collecting response signal measurements from each response sensor 210 while applying the excitation signal to the first exciter device 214, the controller 302 selects the next exciter device (step 516) and repeats the process of collecting response signal outputs from each response sensor 210 while the excitation signal is applied to the second exciter device 214. This process is also repeated until response signal data has been collected by the controller 302 from each of the plurality response sensors 210 while the excitation signal is applied to each of the plurality of exciter devices 214—or, in other words, until response signal data has been collected by the controller 302 for each of a plurality of exciter device and response sensor combinations. When the excitation signal has been applied to all of the exciter devices (step 514) and the response signal data has been collected from each response sensor (step 510), then the controller 302 applies the mathematical transformation to the collected data in order to determine the system response function at the target point of the SUT 208 (e.g., the center point 103 of the steering gear 101 in the example of FIG. 1) (step 518).

Following block 518, the controller 302 may return to block 502 of the method 500 and repeat the method 500 following replacement of the SUT 208 with a second SUT (which may be a same type of component or a different kind of component that the first SUT 208). The controller 302 proceeds to implement the rest of the method 500 with the second SUT coupled to the fixture 202 without altering the known position and the known orientation of the exciter devices 214. For example, the controller 302 selectively and controllably operates the plurality of exciter devices 214 to apply the plurality of excitation forces to the second SUT as described above, without altering the known position and the known orientation of the exciter devices 214 relative to the fixture which may reduce the risk of inconsistent measurement results. In some implementations the same process may be repeated without a SUT coupled to the fixture 202, (for example, fixture 202 alone). The resulting SRFs thus characterize the dynamic properties of the fixture 202 and the test bench onto which the fixture 202 is mounted. The obtained SRFs may be referred to as “passive receiver” properties expressed, for example, as impedances which may be used for dynamic sub-structuring (coupling/decoupling) and/or as a validation measurement (for example, to verify that the test bench is set up correctly).

Additionally, because the location and orientation of the instrumentation on each fixture 206 is known and because the fixture 206 is configured to selectively coupled to each SUT at the same known point (e.g., the steering mount 106 of the steering gear 101 in the example of FIG. 1), the controller 302 can be pre-programmed and/or pre-calibrated to know the position of the instrumentation relative to a known point on the SUT (e.g., the central point 103 of the steering gear 101 in the example of FIG. 1). Forces and moments can then be accurately projected into the central point 103 using a mathematical coordinate transformation. Accordingly, the use of the fixture facilitates full description of the dynamics (e.g., 3 translations and 3 rotations) at the point of interest in an SUT.

By using one or more fixture mounts that are selectively couplable to multiple different SUTs (for example, multiple different steering systems 101 produced by a production/assembly line) and with the particular placement of the exciter devices 214 away from the coupling interface 212A, 212B of the respective fixture 206 and the SUT 208, consistent excitation/response measurements can be collected for SRF characterization of multiple different types and sizes of structures in various different types of environments (for example, as mentioned above, underwater, chemically abrasive environments, and the like). This reduces measurement time and effort and may improve measurement accuracy. Also, only response sensors 210 (and not the exciter devices) are necessary to position at the coupling interface 212 for performing the reciprocal measurement method described herein. As the response sensors 210 are generally more compact than exciter devices 214 such as those positioned further downstream on the fixture, this allows for the coupling interface between the system 200 and the SUT 208 to be configured smaller, allowing for smaller SUT systems (and parts thereof) to be measured.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, when guided by the concepts and principles disclosed herein. will be capable of generating such software instructions and programs and ICs. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

A device or structure that is “configured” in a certain way is configured in at least that way but may also be configured in ways that are not listed.

The terms “coupled,” “coupling,” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical clement depending on the particular context.

Various features and advantages of the embodiments presented herein are set forth in the following claims.

What is claimed is:

1. A system for characterizing system response functions of a structure-under-test, the system comprising:
a fixture selectively coupleable at a coupling interface to the structure-under-test, wherein the fixture is configured to hold the structure-under-test at a known position and known orientation relative to the fixture;
a plurality of exciter devices, wherein each exciter device of the plurality of exciter devices is coupled downstream from the coupling interface at different locations and different orientations and is configured to controllably apply an excitation force to the fixture; and
a plurality of response sensors, wherein each response sensor of the plurality of response sensors is positioned at a known location and a known orientation relative to the fixture, each of the plurality of response sensors being configured to sense a dynamic response, wherein the excitation force applied to the fixture by each of the exciter devices is transferred by the fixture to the structure-under-test, and wherein the dynamic response measured by each of the response sensors is indicative of a reciprocal response of the fixture to the applied excitation force.

2. The system of claim 1, further comprising a controller configured to
receive dynamic response data from the plurality of response sensors indicative of the reciprocal response of the fixture to the applied excitation force;
apply a mathematical transformation to the received dynamic response data to calculate a dynamic response of the fixture and the structure-under-test coupled to the fixture at a target point of the structure-under-test; and
calculate a system response function of the fixture and the structure-under-test coupled to the fixture based at least in part on the calculated dynamic response at the target point.

3. The system of claim 2, wherein the controller is further configured to selectively apply an excitation signal to the plurality of exciter devices, wherein the excitation force applied by the plurality of exciter devices corresponds to the excitation signal,
wherein applying the mathematical transformation includes applying the mathematical transformation to excitation force data indicative of the excitation force applied by the plurality of exciter devices to calculate a corresponding excitation force at a first target point of the fixture and the structure-under-test coupled to the fixture, and
wherein calculating the system response function of the fixture and the structure-under-test coupled to the fixture includes calculating the system response function based at least in part on the calculated corresponding excitation force at a first target point and the calculated dynamic response at a second target point, wherein the first target point and the second target point are the same or are different from each other.

4. The system of claim 1, wherein the plurality of exciter devices includes a plurality of vibrational exciter devices each configured to apply a vibration force along an operating axis of the vibrational exciter device, wherein the plurality of vibrational exciter devices are coupled to the fixture at locations and orientations configured to
apply linear vibrational forces in directions parallel to at least three different axes relative to a target point of the fixture and the structure-under-test coupled to the fixture, and
apply rotational vibrational forces around each of the at least three different axes relative to the target point of the fixture and the structure-under-test coupled to the fixture.

5. The system of claim 1, wherein the plurality of response sensors includes at least one response sensor coupled at or in proximity to the coupling interface.

6. The system of claim 1, wherein the plurality of response sensors includes a plurality of exciter devices coupled to the fixture at locations and orientations configured to
sense linear dynamic responses in directions parallel to at least three different axes relative to a target point of the fixture and the structure-under-test coupled to the fixture, and
sense rotational dynamic responses around each of the at least three different axes relative to the target point of the fixture and the structure-under-test coupled to the fixture.

7. The system of claim 1, further comprising a controller configured to apply a mathematical coordinate transformation to project forces and moments of the excitation forces applied by the plurality of exciter devices and dynamic responses sensed by the plurality of response sensors to a target point of the structure-under-test based at least in part on known locations and known orientations of the exciter devices and the response sensors relative to the target point of the fixture and the structure-under-test coupled to the fixture.

8. The system of claim 7, wherein the locations and orientations of the exciter devices and the response sensors relative to the target point of the structure-under-test are known due to a known arrangement of the plurality of exciter devices and the plurality of response sensors on the fixture and a known geometry of at least selected from the group consisting of the structure-under-test, the fixture, a fixture adaptor, and a test bench platform.

9. The system of claim 7, wherein applying the mathematical coordinate transformation includes applying at least one selected from a group consisting of a virtual point transformation, a finite difference approximation, and a multi-point connection.

10. The system of claim 1, wherein the plurality of exciter devices includes an exciter device positioned on a test bench platform supporting the fixture and wherein the excitation force applied to the fixture is applied through the test bench platform.

11. The system of claim 1, wherein at least one response sensor of the plurality of response sensors is coupled to the structure-under-test.

12. A method of characterizing a system response function using the system of claim 1, the method comprising:
coupling a first structure-under-test to the fixture;
selectively and controllably operating the plurality of exciter devices to apply a plurality of excitation forces to the first structure-under-test;
receiving force response data from the plurality of response sensors indicative of the response of the first structure-under-test to each of the applied excitation forces;
applying a mathematical coordinate transformation to project translational and rotational dynamic responses sensed by the response sensors to a target point of the fixture and the first structure-under-test coupled to the fixture; and
calculating a system response function for the fixture and the first structure-under-test coupled to the fixture based at least in part on the projected responses and the excitation forces.

13. The method of claim 12, further comprising:
decoupling the first structure-under-test from the fixture;
coupling a second structure-under-test to the fixture;
selectively and controllably operating the plurality of exciter devices to apply the plurality of excitation forces to the second structure-under-test, wherein the known position and the known orientation of the exciter devices relative to the fixture is not altered;
receiving force response data from the plurality of response sensors indicative of the response of the second structure-under-test to each of the applied excitation forces;
applying the mathematical coordinate transformation to project forces and moments of the excitation forces applied by the exciter devices and dynamic responses sensed by the response sensors to target points of the fixture and the second structure-under test coupled to the fixture; and
calculating a system response function for the second structure-under-test based at least in part on the projected responses and forces.

14. The method of claim 12, further comprising:
operating the exciter devices one at a time to calculate the system response function.

15. The method of claim 12, further comprising:
operating a plurality of exciter devices simultaneously using different excitation signals to calculate the system response function.

16. The method of claim 12, further comprising:
decoupling the first structure-under-test from the fixture;
selectively and controllably operating the plurality of exciter devices to apply the plurality of excitation forces to the fixture, wherein the known position and the known orientation of each of the plurality of exciter devices relative to the fixture are not altered;
receiving force response data from the plurality of response sensors indicative of the response of the fixture to each of the applied excitation forces;
applying the mathematical coordinate transformation to project forces and moments of the excitation forces applied by the plurality of exciter devices and dynamic responses sensed by the plurality of response sensors to a target point at which a structure-under-test would be coupled to the fixture; and
calculating a system response function for the fixture based on the projected forces and moments.
